(19) United States
(12) Patent Application Publication
(10) Pub. No.: US 2015/0234798 A1
(43) Pub. Date: Aug. 20, 2015

(54) SYSTEM AND METHOD FOR CHANGING A WEB UI APPLICATION APPEARANCE BASED ON STATE THROUGH CSS SELECTOR CASCADING

(71) Applicants: Sorin Alexandru MOCANU, Adliswil (CH); Oana GHEORGHITA, Zurich (CH); Chia-Nee Michelle CHEN, Adliswil (CH)

(72) Inventors: Sorin Alexandru MOCANU, Adliswil (CH); Oana GHEORGHITA, Zurich (CH); Chia-Nee Michelle CHEN, Adliswil (CH)

(73) Assignee: GOOGLE INC., Mountain View, CA (US)

(21) Appl. No.: 13/486,486

(22) Filed: Jun. 1, 2012

(51) Int. Cl. G06F 17/22

(52) U.S. Cl. CPC G06F 17/2264; G06F 17/2247

(57) ABSTRACT

A method and system for adjusting a web application user interface (UI). The method includes rendering the web application UI and detecting at least one state change of a web application or affecting online accessibility of the web application using a processor of a computing device. The method further includes adjusting one or more elements of the web application UI in dependence upon the at least one state change, wherein the adjusting comprises utilization of cascading style sheets (CSS) with at least one of descendant selectors and cascading rules. The method also includes rendering the web application UI with the adjusted one or more elements. The utilization of the cascading style sheets (CSS) classes includes applying a new property to a UI element, and through one or more descendant selectors, applying one or more new properties to one or more sublevel elements of the UI element.

### BACKGROUND

1. Field of the Disclosure

The present disclosure generally relates to changing web user interface (UI) application appearances and/or functions, and more specifically relates to a system and method for changing a web UI application visible appearance and/or functionality based on state through cascading style sheet (CSS) selector cascading.

2. Background Information

A web application is an application that may be accessed over a network such as the Internet or an intranet. The term may also include a computer software application that is coded in a browser-supported language (such as JAVASCRIPT®, combined with a browser-rendered markup language such as, for example, HTML) and reliant on a common web browser to render the application executable.

Examples of web applications include office software (word processors, online spreadsheets, calendars, and presentation tools), webmail, online retail sales, online auctions, wikis and many other functions. Web applications also include more advanced applications such as project management, computer-aided design, video editing and point-of-sale applications. Web applications are popular due to the ubiquity of web browsers, and the convenience of using a web browser as a client. The ability to update and maintain web applications without distributing and installing software on potentially thousands of client computers is a key reason for web applications popularity.

Cascading Style Sheets (CSS) is a style sheet language used for describing the presentation semantics (the look and formatting) of a document written in a markup language. CSS' most common application is to style web pages written in HTML and XHTML, but the CSS language can also be applied to any kind of XML document, including plain XML, SVG and XUL. CSS is designed primarily to enable the separation of document content (written in HTML or a similar markup language) from document presentation, including elements such as the layout, colors, and fonts. This separation of content and presentation can improve content accessibility, provide more flexibility and control in the specification of presentation characteristics, enable multiple pages to share formatting, and reduce complexity and repetition in the structural content.

Within a web-based application, however, a user may experience a change of state, such as, for example, a change in viewport size (e.g., the user changes the window size for the web-based application). Conventional approaches to utilization of CSS are statically applied within a user session (e.g., at initiation), however, and do not adjust a UI dynamically (e.g., in real time) in dependence upon a detected change in state. Additionally, conventional approaches to utilization of CSS are directed to appearance aspects of the web-based application and not functionality aspects of the web-based application. As such, there remains room for improving the utilization of CSS within a web UI application.

### SUMMARY OF THE DISCLOSURE

The present disclosure, through one or more of its various aspects, embodiments, and/or specific features or sub-components, provides various systems, servers, methods, media, and programs for interfacing compiled codes, such as, for example, JAVASCRIPT scripts.

In embodiments, the present disclosure is directed to a computer-implemented method for adjusting a web application user interface (UI). The method comprises rendering the web application UI, and detecting at least one state change of a web application using a processor of a computing device. Additionally, the method comprises adjusting one or more elements of the web application UI in dependence upon the at least one state change, wherein the adjusting comprises utilization of cascading style sheets (CSS) classes to identify the one or more elements for applying one or more new properties thereto in order to adjust the one or more elements of the web application UI. Further, the method comprises rendering the web application UI with the adjusted one or more elements. The utilization of the cascading style sheets (CSS) classes includes applying a new property to a UI element, and through one or more descendant selectors, applying one or more new properties to one or more sublevel elements of the UI element.

According to another aspect of the present disclosure, the at least one state change comprises at least one of a viewport size change, a connectivity change and a pending alert.

According to a further aspect of the present disclosure, the connectivity change comprises at least one of a loss or realization of Internet connectivity, and a loss or realization of intranet connectivity.

According to yet another aspect of the present disclosure, the adjusting the one or more elements of the web application UI comprises adjusting an appearance of one or more elements of the web application.

According to another aspect of the present disclosure, the adjusting the one or more elements of the web application UI comprises adjusting a functionality of one or more elements of the web application.

According to a further aspect of the present disclosure, at least one of the detecting and adjusting is performed in real-time to dynamically and elastically adapt the web application UI in dependence upon a currently detected state.

According to yet another aspect of the present disclosure, the utilization of CSS classes provides for at least one of a centralized control by a UI control tool and a reduced number of individually-controlled UI changes.

According to a further aspect of the present disclosure, descendant selectors are configured to control sublevel visual UI elements.

According to another aspect of the present disclosure, the adjusting comprises iterating through a plurality of elements and/or a plurality of sublevel elements.

According to a further aspect of the present disclosure, the adjusting comprises replacing one or more style sheets.

According to yet another aspect of the present disclosure, the adjusting comprises utilization of CSS transitions to smoothly transition one or more elements of the web application UI from a first appearance and/or functionality to a second appearance and/or functionality.

According to another aspect of the present disclosure, the detecting comprises utilization of CSS media queries.

In embodiments, the present disclosure is directed to a system for adjusting a web application user interface (UI). The system comprises a processor operable to render the web application UI, and at least one detector configured for detecting at least one state change of a web application. The system also comprises a UI controller configured for adjusting one or more elements of the web application UI in dependence upon the at least one state change, wherein the UI controller is configured to utilize cascading style sheets (CSS) classes to identify the one or more elements for applying one or more new properties thereto in order to adjust the one or more elements of the web application UI. The processor is further operable to render the web application UI with the adjusted one or more elements. The utilization of the cascading style sheets (CSS) classes includes applying a new property to a UI element, and through one or more descendant selectors, applying one or more new properties to one or more sublevel elements of the UI element.

According to another aspect of the present disclosure, the at least one state change comprises at least one of a viewport size change, a connectivity change, and a pending alert.

According to another aspect of the present disclosure, the connectivity change comprises at least one of a loss or realization of Internet connectivity, and a loss or realization of intranet connectivity.

According to a further aspect of the present disclosure, the adjusting the one or more elements of the web application UI comprises adjusting an appearance of one or more elements of the web application.

According to yet another aspect of the present disclosure, the adjusting the one or more elements of the web application UI comprises adjusting a functionality of one or more elements of the web application.

According to another aspect of the present disclosure, at least one of the detector and the UI controller operate in real-time to dynamically and elastically adapt the web application UI in dependence upon a currently detected state.

According to a further aspect of the present disclosure, the utilization of the CSS classes provides for at least one of a centralized control by the UI control tool and a reduced number of individually-controlled UI changes.

According to yet another aspect of the present disclosure, descendant selectors are configured to control sublevel visual UI elements.

According to a further aspect of the present disclosure, the UI controller is configured to iterate through elements.

According to yet another aspect of the present disclosure, the UI controller is configured to replace one or more style sheets.

According to another aspect of the present disclosure, the UI controller is configured utilize CSS transitions to smoothly transition one or more elements of the web application UI from a first appearance and/or functionality to a second appearance and/or functionality.

According to a further aspect of the present disclosure, the at least one detector is configured utilize CSS media queries.

According to yet another aspect of the present disclosure, the at least one detector comprises at least one of a viewport size detector and an online connectivity detector.

In embodiments, the present disclosure is directed to a computer program product for adjusting a web application user interface (UI). The computer program product comprises a computer usable non-transitory storage medium having readable program code embodied in the storage medium. The computer program product includes at least one component operable to render the web application UI, detect at least one state change of a web application, adjust one or more elements of the web application user interface (UI) in dependence upon the at least one state change, wherein the adjusting comprises utilization of cascading style sheets (CSS) classes to identify the one or more elements for applying one or more new properties thereto in order to adjust the one or more elements of the web application UI, and render the web application UI with the adjusted one or more elements. The utilization of the cascading style sheets (CSS) classes includes applying a new property to a UI element, and through one or more descendant selectors, applying one or more new properties to one or more sublevel elements of the UI element.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary system for use in accordance with aspects of the present disclosure.

FIG. 2 illustrates an exemplary client-server system in accordance with aspects of the disclosure.

FIG. 3 illustrates an exemplary block diagram 300 in accordance with aspects of the disclosure.

FIGS. 4 and 5 illustrate exemplary and non-limiting UI layouts with differing viewport sizes and differently configured UI layouts in accordance with aspects of the disclosure.

FIG. 6 illustrates an exemplary flow diagram for practicing aspects of the disclosure.

### DETAILED DESCRIPTION

The present disclosure, through one or more of its various aspects, embodiments and/or specific features or sub-components, is thus intended to bring out one or more of the advantages as specifically noted below.

### Exemplary System

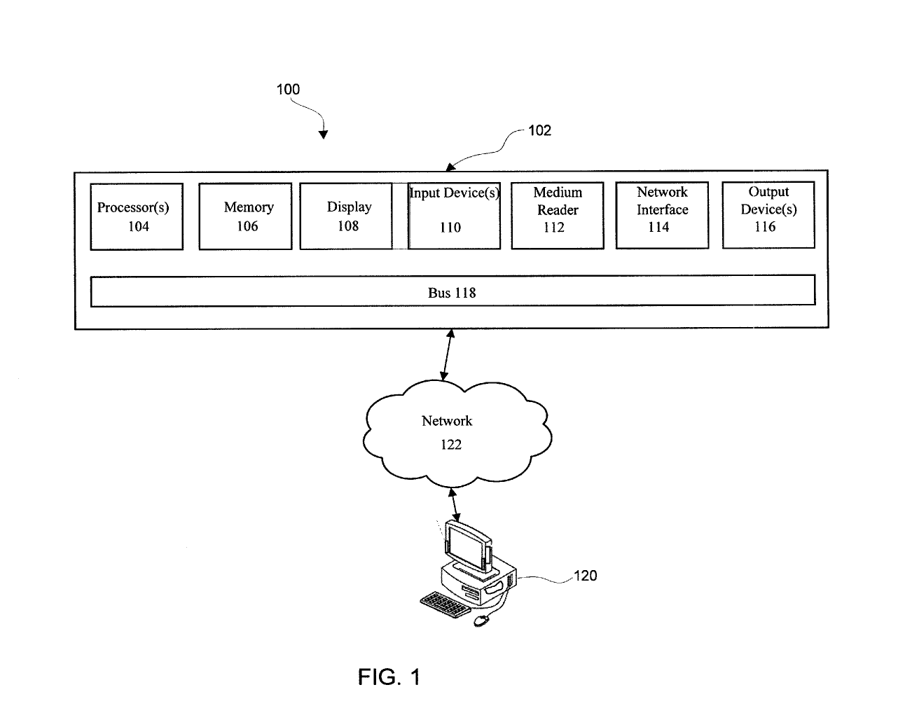

FIG. 1 is an exemplary system for use in accordance with the embodiments described herein. The system 100 is generally shown and may include a computer system 102, which is generally indicated. The computer system 102 may operate as a standalone device or may be connected to other systems or peripheral devices. For example, the computer system 102 may include, or be included within, any one or more computers, servers, systems, communication networks or cloud environment.

The computer system 102 may operate in the capacity of a server in a network environment, or the in the capacity of a client user computer in the network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, addition embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of known memories or a single storage.

As shown in FIG. 1, the computer system 102 may include a computer display 108, such as a liquid crystal display, an organic light emitting diode, a flat panel display, a solid state display, a cathode ray tube, a plasma display, or any other known display.

The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 102 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly known and understood as being included with or within a computer system, such as, but not limited to, an output device 116. The output device 116 may be, but is not limited to, a speaker, an audio out, a video out, a remote control output, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, or any other network commonly known and understood in the art. The network 122 is shown in FIG. 1 as a wireless network. However, those skilled in the art appreciate that the network 122 may also be a wired network.

The additional computer device 120 is shown in FIG. 1 as a personal computer. However, those skilled in the art appreciate that, in alternative embodiments of the present application, the device 120 may be a laptop computer, a tablet PC, a personal digital assistant, a mobile device, a palmtop computer, a desktop computer, a communications device, a wireless telephone, a personal trusted device, a web appliance, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

### Overall System/Method

In embodiments, the disclosure is directed to a system and method for providing an “elastic” UI, which is operable to dynamically adapt (e.g., in real time) one or more UI layout requirements through CSS selector cascading in dependence upon a current state. Additionally, the present disclosure is directed to a system and method for changing UI appearance and/or function of one or more various web UI elements through CSS selective cascading based on an application state and/or various signals, including: viewport size, online status (e.g., Internet connectivity), and the existence of pending alerts, amongst other application states and signals. In accordance with aspects of the disclosure, by utilizing CSS selective cascading, the system and method provide a controllable approach to change one or more properties of a view with, for example, one or a reduced number of components. In embodiments, the system and method are operable to dynamically and/or elastically adapt a web UI based on one or more detected application states (e.g., viewport size, and Internet connectivity, amongst other contemplated application states). Implementing the present disclosure provides for a centralized behavior, in which, for example, one component is operable to detect one or more state changes, and determine, using CSS selective cascading, what UI alterations the UI controller should apply. In accordance with aspects of the present disclosure, through utilization of CSS selective cascading, a number of individually-controlled changes can be reduced, for example, by using descendent selectors to control sublevel visual elements. For example, when a new property is applied to an element, using descendant selectors, a new property may be applied to a sublevel element (e.g., a descendant of the element) based on the new property of the element.

### Cascading Style Sheets

CSS is designed primarily to enable the separation of document content (written in HTML or a similar markup language) from document presentation, including elements such as the layout, colors, and fonts. CSS allows the same markup page to be presented in different styles for different rendering methods, such as on-screen, in print, by voice (when read out by a speech-based browser or screen reader) and on Braille-based, tactile devices. CSS may also be used to allow the web page to display differently depending on the screen size or device on which it is being viewed.

Prior to CSS, nearly all of the presentational attributes of HTML documents were contained within the HTML markup. For example, all font colors, background styles, element alignments, borders and sizes had to be explicitly described, often repeatedly, within the HTML. CSS allows authors to move much of that information to a separate style sheet resulting in considerably simpler HTML markup.

CSS specifies a priority scheme to determine which style rules apply if more than one rule matches against a particular element. In this so-called cascade, priorities or weights are calculated and assigned to rules, so that the results are predictable.

In CSS, selectors are used to declare which of the markup elements a style applies to—a kind of match expression. For example, selectors may apply to all elements of a specific type, or only those elements that match a certain attribute; elements may be matched depending on how they are placed relative to each other in the markup code, or on how they are nested within a Document Object Model (DOM). In CSS, descendent selectors may be used to match an element that is the descendant of another element in a document tree. Descendant selectors may be used to express a relationship in a pattern. For example, a descendant selector of the form “A B” matches when an element B is an arbitrary descendant node (e.g., a child node) of some ancestor element A node. Thus, in CSS, if a top element (e.g., element A) is changed, those descendent elements (e.g., element B), as indicated by descendent selectors, will also be changed.

Style sheets may have three different origins: author, user, and user agent. The author specifies style sheets for a source document according to the conventions of the document language. For example, in HTML, style sheets may be included in the document or linked externally. The user may be able to specify style information for a particular document. For example, the user may specify a file that contains a style sheet or the user agent may provide an interface that generates a user style sheet. Style sheets from these three origins (i.e., author, user, and user agent) may overlap in scope, and they interact according to the cascade. The CSS cascade assigns a weight to each style rule. When several rules apply, the style rule with the greatest weight takes precedence. Rules in user style sheets may have more weight than rules in author style sheets, for example, so that a user with special needs may configure their web page display with more contrasting colors. User and author rules may have more weight than rules in the user agent's (UA's) default style sheet.

### Exemplary Client-Server System

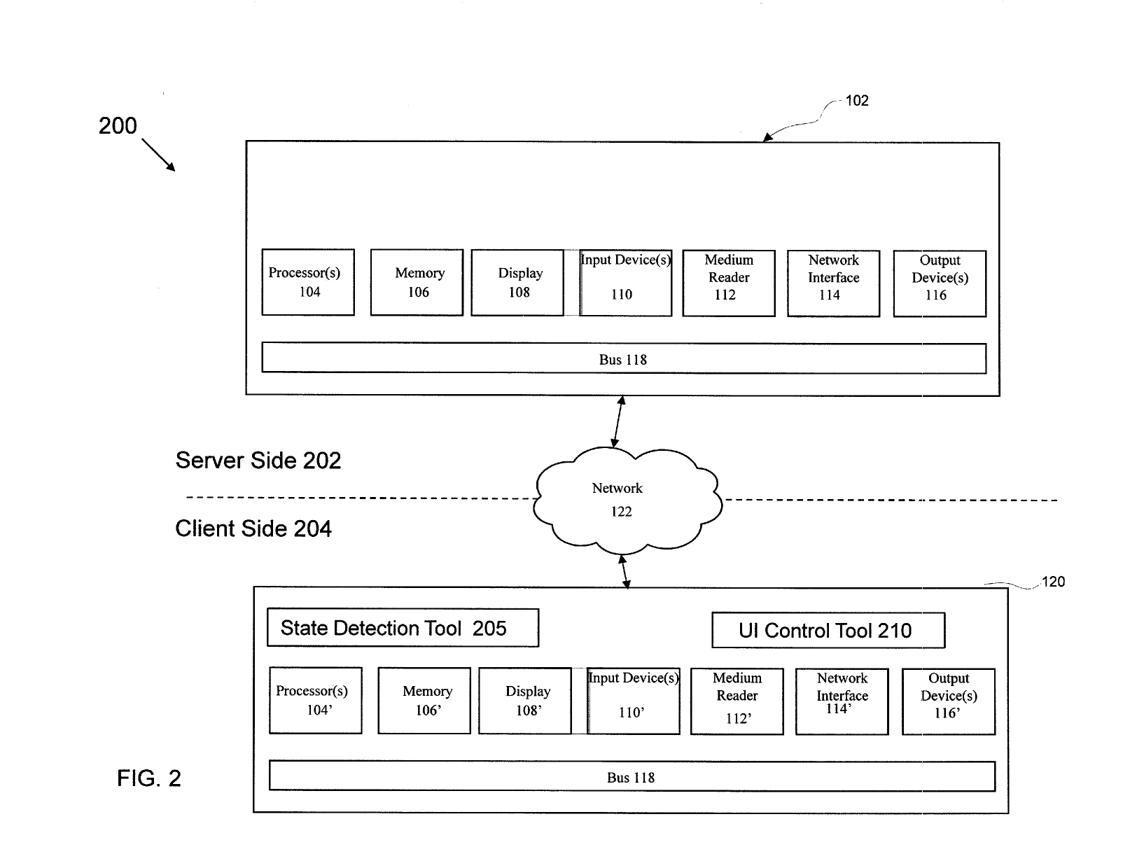

FIG. 2 illustrates an exemplary client-server system 200 in accordance with aspects of the disclosure. As shown in FIG. 2, the client-server system 200 includes the computer system 102 on the server side 202 in communication with one or more additional computer devices 120 on the client side 204.

As illustrated in FIG. 2, the computer device 120 includes at least one processor 104′, a computer memory 106′, a display 108′, one or more input devices 110′, a medium reader 112′, a network interface 114′, and one or more output devices 116′, as described above with regard to the computer system 102. In accordance with aspects of the disclosure, the computer device 120 additionally includes a state detection tool 205 operable to detect one or more current states (e.g., a viewport size and/or a connectivity status, amongst other contemplated current states) of the computer device 120 on the client side 204.

The computer device 120 also includes a UI control tool 210 operable to control and/or adjust one or more elements of the UI in dependence upon the one or more current states. While the non-limiting exemplary embodiment of FIG. 2 illustrates a client side 204 having particular tools, the disclosure contemplates that in embodiments, one or more tools shown on the client side 204 may be located on the server side 202.

### Exemplary Dynamic Layout Implementation

In embodiments, the disclosure is directed to a system and method for providing an “elastic” UI, which is operable to dynamically adapt (e.g., in real time) one or more UI layout requirements through CSS selector cascading in dependence upon a current state. For example, for a calendar web application, the system is operable to dynamically adapt the web UI to a current user viewport (e.g., window) size. In embodiments, the system includes a state detector (e.g., a viewport size detector), which is operable to detect a current viewport size, and an UI controller, which is operable to control (e.g., adjust in real time) the styles applied within the web application (e.g., by a client browser), in dependence upon the current state (e.g., the current viewport size). For example, at initialization, the UI controller may be operable to set initial styles (e.g., webpage layout, spacing, font sizes, color, etc.) based on the initial viewport size. The viewport size detector is operable to detect and/or quantify viewport size changes. Additionally, the viewport size detector is operable to alert the UI controller as to the occurrence of any viewport size changes. The UI controller is operable to apply the appropriate style to the controlled UI node (and, through CSS, their descendent nodes) in dependence upon the currently detected viewport size. Thus, in embodiments, the UI controller applies the updated style to the controlled UI nodes in a dynamic and/or real-time manner.

In accordance with aspects of the disclosure, in a non-limiting and exemplary embodiment, the viewport size detector may be embodied using JAVASCRIPT, wherein a JAVASCRIPT application is operable to detect a resizing of the web application viewport (e.g., window). For example, there are various JAVASCRIPT implementations to provide a viewport size detector. Some libraries (for example, jQuery, prototype.js, YUI, Google Closure, etc.) have their own open-sourced implementation. For example, the Closure implementation is available as “goog.dom.getViewportSize.” Additionally, many browsers expose this information as global read-only properties called document.clientWidth, document.clientHeight. As one of ordinary skill in the art would readily understand how to utilize, for example, JAVASCRIPT to detect a viewport size, no further description is necessary for an understanding of the present disclosure.

In accordance with aspects of the disclosure, in embodiments, a calendar web-based application may utilize descendant selectors and cascading rules to apply the appropriate layout properties depending on the current viewport size. Using descendant selectors allows, for example, the UI controller to manage a number (e.g., a limited number) of UI elements in accordance with aspects of the disclosure. For example, in the calendar web-based application, the UI controller may manage two to three nodes, while descendant CSS selectors allow targeting specific descendants of these two to three nodes.

The following is an exemplary and non-limiting embodiment of a controlled node (e.g., controlled with the UI controller) with a Document Object Model (DOM) ID of “calcontent” in accordance with aspects of the disclosure. Within the “calcontent” node is another element (e.g., a descendent node) with a DOM ID of “resizeme.” With an exemplary and non-limiting embodiment, the UI controller is configured, for example, to support three modes: default, small and tiny, wherein “small” and “tiny” modes correspond to a CSS class of “ui-small” and “ui-tiny”, respectively.

With an exemplary and non-limiting embodiment, the HTML may include the following code:

<div id=calcontent>
Some content here
<div id=resizeme>Some resizable area</div> </div>

In accordance with aspects of the disclosure, this code establishes “calcontent” as a UI node, and “resizeme” as a descendent node of the “calcontent” UI node, which can be targeted using CSS. While only one descendent node is described with this non-limiting example, it should be understood that other descendent nodes could also be simultaneously (or successively) targeted using CSS. For example, other descendent nodes within the context of a calendar application may include a calendar list, weekly notes, a small calendar, amongst other contemplated descendent nodes. In accordance with aspects of the disclosure, in embodiments, the present system is operable to utilize the change of one ancestor to trigger various changes, for example, in multiple elements.

With an exemplary and non-limiting embodiment, the CSS declaration may include the following code:

#resizeme {/* metrics for the default mode */padding: 10px;}
#calcontent.ui-small #resizeme {/* metrics when the small size should be
displayed */ padding: 5px;}
#calcontent.ui-tiny #resizeme {/* metrics when the tiny size should
be displayed
*/ padding: 1px;}

With the above example, the client-side computer device may initially render the web UI based on the default mode, such that the padding is set at 10 px (or pixels). Upon the state detector (e.g., the state detection tool 205) detecting a viewport size change (e.g., the viewport size has been decreased by a user), using CSS, the UI controller (e.g., the UI control tool 210) is operable to display the web UI using the “ui-small” style (e.g., with a padding of 5 px) or the “ui-tiny” style (e.g., with a padding of 1 px) depending on the metrics, which define when these styles should be displayed. By altering a padding, the present disclosure is operable to dynamically provide different amounts of clear area (or spacing) around content (e.g., text) in dependence upon the current state. Thus, in accordance with aspects of the disclosure, an “elastic” UI is operable to dynamically adapt (e.g., in real time) one or more UI layout requirements through CSS selector cascading in dependence upon the current state.

It should be understood that while the above exemplary embodiment used padding (or white space) as an example of a CSS property that can be modified, the disclosure contemplates that any CSS property may be modified using the present system. Such CSS properties include, for example: color; margins; borders; font size; visibility; and “display” size, amongst other contemplated CSS properties.

### Exemplary Block Diagram

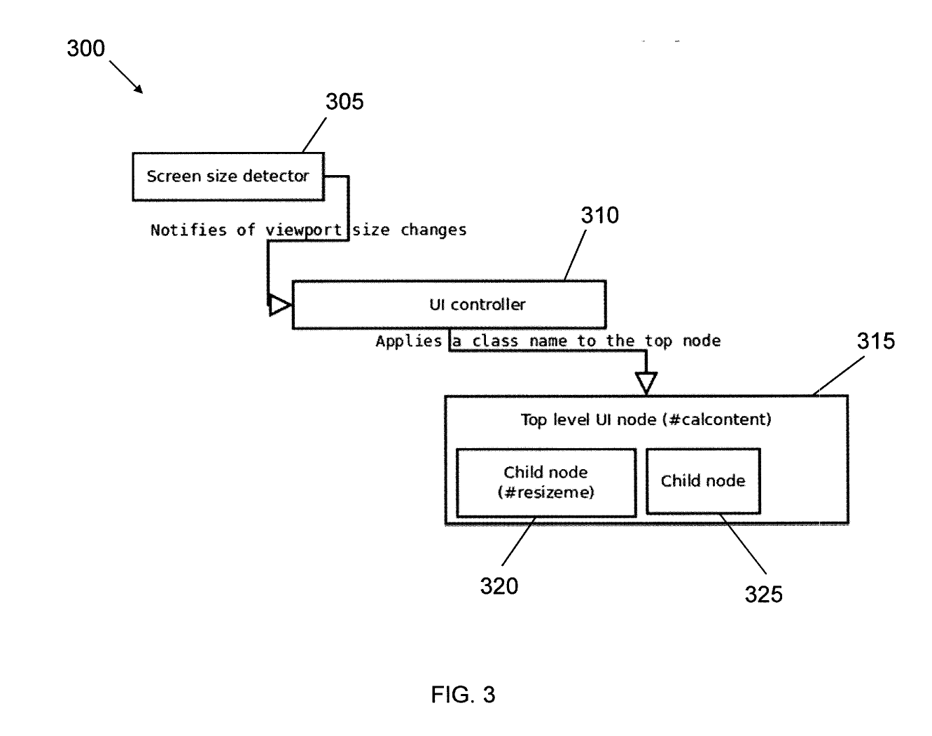

FIG. 3 illustrates an exemplary and non-limiting block diagram 300 in accordance with aspects of the disclosure. As shown in FIG. 3, a screen size detector 305 is operable to detect any viewport size changes and notify the UI controller 310 of any viewport size changes (e.g., the occurrence of a change and/or the amount or degree of change). The UI controller 310 is operable to change one or more UI elements through CSS selectors by applying (or updating) a class name to a top node 315 (e.g., “#calcontent”). As shown in FIG. 3, the top node 315 includes one or more descendent (e.g., children) nodes 320 and 325. With this exemplary and non-limiting block diagram 300, child node 320 is targeted (or designated) as “#resizeme,” and child node 325 is not currently targeted (e.g., it is not currently being utilized). In accordance with aspects of the disclosure, the top level UI node 315 is operable to update the descendent node 320 through CSS descendent selectors in dependence upon the change in its class name (i.e., the class name of the top level UI node 315) performed by the UI controller 310. In contrast, as there is no descendent selector rule currently targeting descendent node 325, a change in the class name of the top level UI node 315 will not cause a change to descendent node 325.

While the screen size detector 305 and the UI controller 310 are described above as software, firmware, and/or hardware, the disclosure contemplates that the screen size detector 305 and/or the UI controller 310 may be embodied as entirely software, entirely hardware, and/or entirely firmware. Additionally, as a software embodiment, the system may be aware of signals coming from other software and/or hardware systems through the OS and browser interfaces (for example, the internal hardware clock, a laptop computer being connected to a larger display; a GPS sensor on a mobile or laptop browser, a proximity sensor on a mobile phone, and/or a generic hardware device, which allows monitoring through web protocols that allow connections from the present system, amongst other contemplated signals from other software and/or hardware systems.

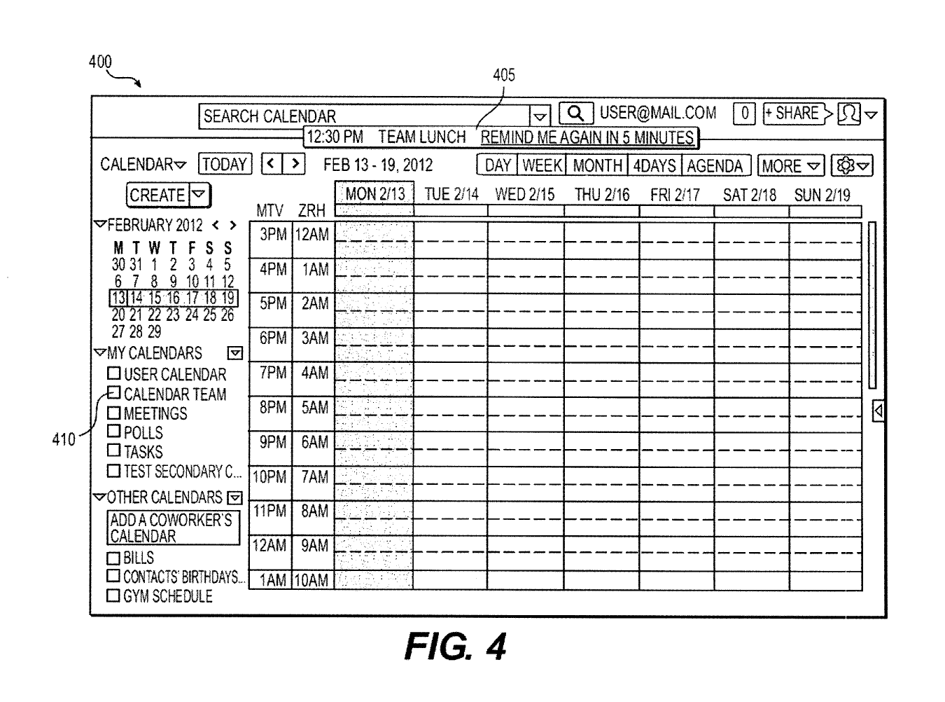

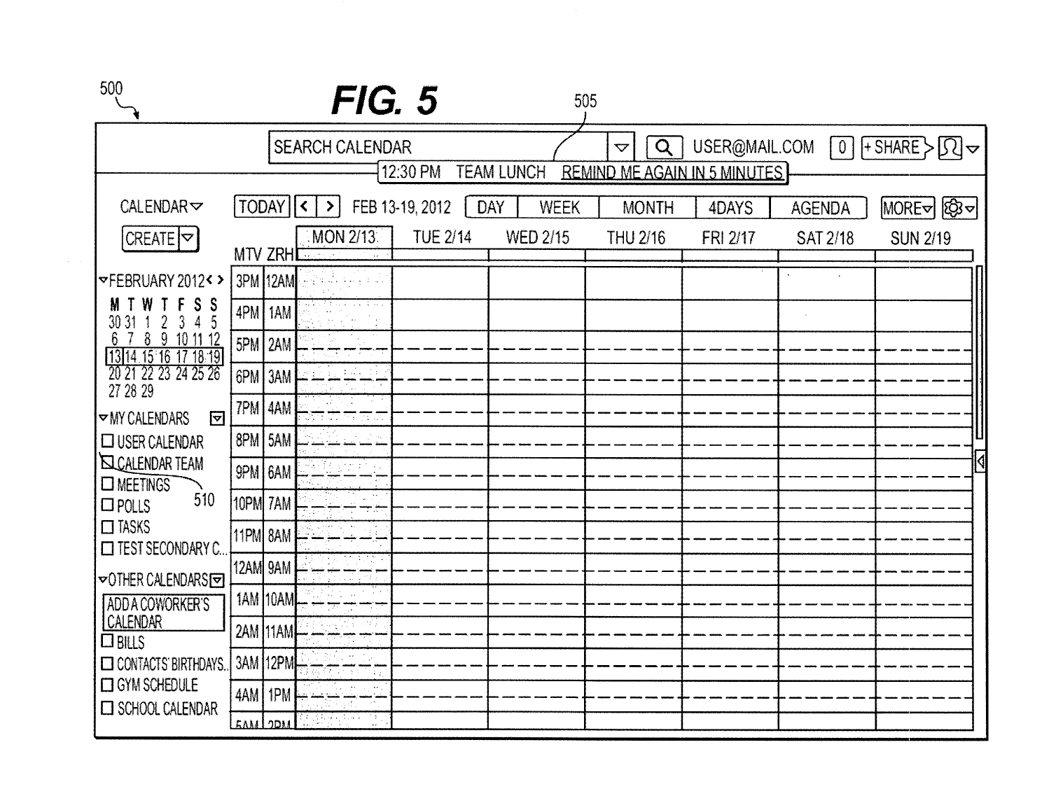

FIGS. 4 and 5 illustrate exemplary and non-limiting UI layouts with differing viewport sizes and differently configured UI layouts provided using the present system in accordance with aspects of the disclosure. As shown in FIGS. 4 and 5, respectively, the UI controller (e.g., the UI control tool 310) is operable to configure (or render) the UI layout 400 for a smaller viewport, and configure (or render) the UI layer 500 for a relatively larger viewport. For example, as shown in FIG. 4, the UI controller (e.g., the UI control tool 310) is operable to configure (or render) the alert window 405 with little spacing (or padding). Additionally, the UI controller (e.g., the UI control tool 310) is operable to configure (or render) the calendars section 410 with little spacing (or padding). In contrast, as shown in FIG. 5, which illustrates a relatively larger viewport, the present system is operable to detect the current viewport size and/or a change in viewport size, and render the UI with the alert window 505 and the calendars section 510 having increased spacing (or padding). While the exemplary and non-limiting layouts 400 and 500 illustrate differently configured UI layouts provided using the present system with changes to the spacing (or padding), it should be understood that the present system is operable to affect other contemplated changes to UI layouts.

### Exemplary Dynamic Appearance/Functionality Implementation

In further embodiments, the present disclosure is directed to a system and method for changing the appearance and/or functionality of one or more web UI elements in dependence upon changes of state (e.g., when a user acquires or loses Internet or intranet connectivity). In embodiments, the system includes a state detection tool (e.g., a connectivity detector) operable to detect a current state of connectivity (e.g., Internet connectivity, intranet connectivity or online status), and an UI controller, which is operable to control the one or more styles applied in a web application at the client side (e.g., within a web-based email application), in dependence upon the current state (e.g., current connectivity status). In accordance with aspects of the disclosure, in embodiments, the UI controller is operable to, for example, partially disable one or more UI elements when a user loses Internet connectivity. For example, if a user loses Internet connectivity for example, within a web-based email application, the system may gray-out and/or disable a “send” button, indicating the offline status to the user. In embodiments, the system may be operable to alter the UI, for example, to provide a visual cue, render one or more buttons inoperable (such that it cannot be actuated), or hide an element (or reduce its size), amongst other contemplated alterations.

By implementing the present disclosure, the system is operable to provide one or more indications to a user as to what functions of the web application are currently available (or not available). That is, for example, if a user within a web-based email application loses Internet connectivity, some functions of the email application, such as the ability to send an email, would not currently be available. The present invention is operable, through utilization of CSS, to modify one or more elements of the UI to indicate a loss of functionality and/or disable a function. For example, within a web-based email application, the system may gray-out and/or disable the “send” button, so that the user is aware that mail cannot currently be sent (and to prevent attempts to send email). In embodiments, in accordance with additional aspects of the disclosure, if a user loses Internet connectivity, the web-based email application may be operable to cache an unsent email, and send the email upon restoration of Internet connectivity. Additionally, within a web-based calendar application in which, for example, meeting rooms may be reserved (or booked), upon the loss of Internet (or Intranet) connectivity, the system may gray-out and/or disable a “reserve room” button, so that the user is aware that the reservation system cannot currently be accessed.

In accordance with aspects of the disclosure, in embodiments, the connectivity detector may be operable to detect when communication is lost between a client running the web-based application and a server. For example, the present disclosure may utilize window.navigator.onLine property exposed in JAVASCRIPT, together with the window.onOnline and window.onOffline properties to detect when communication is lost between a client running the web-based application and a server.

While the above exemplary embodiment is directed to a system and method for changing the appearance and/or functionality of one or more web UI elements in dependence upon change in Internet or intranet connectivity, the disclosure contemplates changing the appearance and/or functionality of one or more web UI elements in dependence upon other changes of state. For example, in embodiments, a system and method may change the appearance and/or functionality of one or more web UI elements in dependence upon the existence of pending alerts. For example, when an alert is detected, the system may change the appearance of the web application to more clearly indicate the alert (e.g., the alert indication area becomes red and the fonts and colors for the rest of the application become dimmed by 50% to indicate immediate action).

### Iterating Through Elements

In further embodiments, the present invention is directed to a system and method for iterating through elements, for example, to partially disable UI elements when a user loses Internet connectivity. For example, during the initial load and on subsequent Internet connectivity changes, the UI controller is operable to iterate through the DOM and apply appropriate styles to all elements carrying the “disabled” CSS class.

With an exemplary and non-limiting embodiment, the HTML may include the following code:

```
<div>
  Some content
  <div id=“disableme” class=“button to-disable”>Element which does not
      work when offline</div>
  <div id=“donotdisableme” class=“button”>Element which works when
      offline</div>
</div>
```

In accordance with aspects of the disclosure, this HTML code designates a “button to-disable” CSS class, having, for example, an ID of “disableme” for an element which does not work when offline and a “button” CSS class, having, for example, an ID of “donotdisableme,” for an element which works when offline.

With an exemplary and non-limiting embodiment, the CSS declaration may include the following code:

.disabled {
color: gray;
}

This exemplary and non-limiting code indicates that with this exemplary “disabled” style, all elements having the “button to-disable” CSS class will be altered (e.g., with the UI control tool 210) to have a grey color.

In accordance with aspects of the disclosure, during the initial load and on subsequent connectivity changes, the UI controller (e.g., UI control tool 210) is operable to iterate through the DOM and apply appropriate styles (e.g. the “disabled” style) to all elements carrying the “to-disable” CSS class.

In the action handler where actions on these elements are handled, the existence of the “disabled” class may be assessed to determine whether an action should be ignored. For example, with an exemplary and non-limiting embodiment, the JAVASCRIPT may include the following code:

```
function handleAction(e) {
  if (goog.dom.classes.has(e.target, goog.getCssName(‘disabled’)) {
    // Do nothing
    return;
  }
  // Code to handle action.
  . . .
}
```

The above exemplary code is an example using the Google Closure library. This function is an action handler that first checks whether the DOM node which fired the event (e.target) has “disabled” amongst its CSS classes. The DOM node which fired the event does not have to be the same node as the one that is being checked for the “disabled” CSS class. In the case where the element has the “disabled” class, no further action is performed. Otherwise the action handling continues.

### Replacing Style Sheets

In accordance with additional aspects of the disclosure, in embodiments, as an alternative to using a single style sheet having multiple properties therein, the system and method may utilize a plurality of different style sheets. Upon a detected state change, for example, a resized viewport, the system is operable to apply (or inject) a new style sheet to replace the current style sheet. Thus, in accordance with aspects of the disclosure, a full reload of the application would not be necessary. Rather, the system is operable to redefine one or more properties by applying (or injecting) the new style sheets.

For example, with reference to the viewport size example discussed above, with this multiple style sheet implementation, there may be three different style sheets containing values such as, for example:

```
DefaultStyleSheet:
#resizeme {
  padding: 10px;
}
SmallStyleSheet:
#resizeme {
  padding: 5px;
}
TinyStyleSheet:
#resizeme {
  padding: 1px;
}
```

With the above exemplary and non-limiting style sheets, a first style sheet is identified as the default style sheet, and dictates that when this style sheet is applied, a padding of 10 px is used. A second style sheet is identified as the small style sheet, and dictates that when this style sheet is applied, a padding 5 px is used. The third style sheet is identified as the tiny style sheet, and dictates that when this style sheet is applied, a padding of 1 px is used.

In accordance with aspects of the disclosure, the UI controller is operable to apply (or inject) the most appropriate style sheet file depending on the current state as detected by the state detector.

### CSS Transitions

In accordance with additional aspects of the disclosure, the system is operable to utilize CSS transitions to create a smooth transition between states (e.g., from a default viewport size to a small viewport size). CSS transitions allow property changes in CSS values to occur smoothly over a specified duration. Normally (i.e., absent utilization of CSS transitions) when the value of a CSS property changes, the rendered result is instantly updated, with the affected elements immediately changing from the old property value to the new property value. CSS transitions specify transitions between the old property and the new property using new CSS properties (e.g., intermediate values). These intermediate values are used to animate smoothly from the old state to the new state over time, wherein the system is operable to compute a value of a property transitions over time from the old value to the new value. Therefore, if a script queries the computed style of a property as it is transitioning, the script will see an intermediate value that represents the current animated value of the property.

### CSS Media Queries

In accordance with additional aspects of the disclosure, the system is operable to utilize CSS media queries to target specific device features. Media-dependent style sheets are tailored for different media types. For example, a document may use one font when displayed on a screen and second font when printed. Thus, “screen” and “print” are two exemplary media types that have been defined. In accordance with aspects of the disclosure, media queries extend the functionality of media types by allowing more precise labeling of style sheets. A media query includes a media type and zero or more expressions that check for the conditions of particular media features. Among the media features that can be used in media queries are “width,” “height,” and “color,” amongst other contemplated media features. By using media queries, the present system is operable to tailor presentations to a specific range of output devices without changing the content itself. A media query is a logical expression that is either true or false. A media query is true if the media type of the media query matches the media type of the device where the user agent is running, and all expressions in the media query are true.

### Flow Diagram

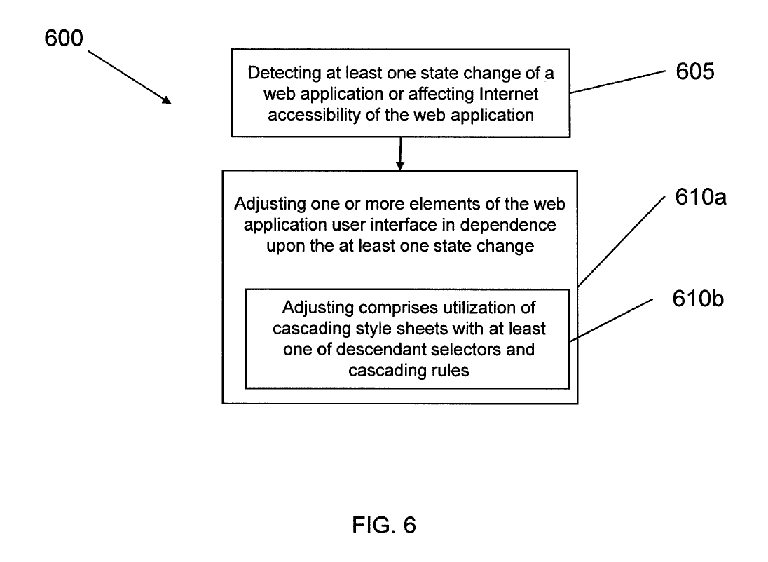

FIG. 6 illustrates an exemplary flow diagram 600 for practicing aspects of the disclosure. The flow diagram of FIG. 6 may be implemented in the exemplary environment of FIG. 1 or FIG. 2. As shown in FIG. 6, at step 605, a state detector (e.g., a viewport size detector and/or a connectivity detector) is operable to detect at least one state change within a web application or affecting Internet accessibility of the web application. At step 610a, a UI controller is operable to adjust one or more elements of the web application UI in dependence upon the at least one state change, and at step 610b, the adjusting comprises utilization of cascading style sheets with at least one of descendant selectors and cascading rules.

Accordingly, the present disclosure provides various systems, servers, methods, media, and programs for generating a graphical comparison of data files. Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A computer-implemented method for adjusting a web application user interface (UI), the method comprising:
rendering the web application UI based on a document object model (DOM) and one or more cascading style sheet (CSS) rules;
detecting at least one state change of the web application using a processor of a computing device from a first state to a second state;
adjusting one or more elements of the web application UI in dependence upon the at least one state change, by changing a class of a UI element of the one or more elements in the DOM from a first class associated with the first state to a second class associated with a second state, wherein the one or more CSS rules include at least a first descendant selector that is associated with the second class and changing the class of the one or more elements applies one or more new properties to one or more sublevel elements of the UI element using the first descendant selector; and
rendering the web application UI with the adjusted one or more elements.

2. The method of claim 1, wherein the at least one state change comprises at least one of a viewport size change, a connectivity change and a pending alert.

3. The method of claim 2, wherein the connectivity change comprises at least one of a loss or realization of Internet connectivity, and a loss or realization of intranet connectivity.

4. The method of claim 1, wherein the adjusting the one or more elements of the web application UI comprises adjusting an appearance of one or more elements of the web application.

5. The method of claim 1, wherein the adjusting the one or more elements of the web application UI comprises adjusting a functionality of one or more elements of the web application.

6. The method of claim 1, wherein at least one of the detecting and adjusting is performed in real-time to dynamically and elastically adapt the web application UI in dependence upon a currently detected state.

7. The method of claim 1, wherein the utilization of CSS classes provides for at least one of a centralized control by a UI control tool and a reduced number of individually-controlled UI changes.

8. The method of claim 1, further comprising configuring descendant selectors to control sublevel visual UI elements.

9. The method of claim 1, wherein the adjusting comprises iterating through a plurality of elements and/or a plurality of sublevel elements.

10. The method of claim 1, wherein the adjusting comprises replacing one or more style sheets.

11. The method of claim 1, wherein the adjusting comprises utilization of CSS transitions to smoothly transition one or more elements of the web application UI from a first appearance and/or functionality to a second appearance and/or functionality.

12. The method of claim 1, wherein the detecting comprises utilization of CSS media queries.

13. A system for adjusting a web application user interface (UI), comprising:
a processor operable to render the web application UI based on a document object model (DOM) and one or more cascading style sheet (CSS) rules;
at least one detector configured for detecting at least one state change of the web application from a first state to a second state; and
a UI controller configured for adjusting one or more elements of the web application UI in dependence upon the at least one state change, by changing a class of a UI element of the one or more elements in the DOM from a first class associated with the first state to a second class associated with a second state, wherein the one or more CSS rules include at least a first descendant selector that is associated with the second class and changing the class of the one or more elements applies one or more new properties to one or more sublevel elements of the UI element using the first descendant selector,
wherein the processor is further operable to render the web application UI with the adjusted one or more elements.

14. The system of claim 13, wherein the at least one state change comprises at least one of a viewport size change, a connectivity change and a pending alert.

15. The system of claim 14, wherein the connectivity change comprises at least one of a loss or realization of Internet connectivity, and a loss or realization of intranet connectivity.

16. The system of claim 13, wherein the adjusting the one or more elements of the web application UI comprises adjusting an appearance of one or more elements of the web application.

17. The system of claim 13, wherein the adjusting the one or more elements of the web application UI comprises adjusting a functionality of one or more elements of the web application.

18. The system of claim 13, wherein at least one of the detector and the UI controller operate in real-time to dynamically and elastically adapt the web application UI in dependence upon a currently detected state.

19. The system of claim 13, wherein the utilization of the CSS classes provides for at least one of a centralized control by the UI control tool and a reduced number of individually-controlled UI changes.

20. The system of claim 13, further comprising descendant selectors configured to control sublevel visual UI elements.

21. The system of claim 13, wherein the UI controller is configured to iterate through elements.

22. The system of claim 13, wherein the UI controller is configured to replace one or more style sheets.

23. The system of claim 13, wherein the UI controller is configured utilize CSS transitions to smoothly transition one or more elements of the web application UI from a first appearance and/or functionality to a second appearance and/or functionality.

24. The system of claim 13, wherein the at least one detector is configured utilize CSS media queries.

25. The system of claim 13, wherein the at least one detector comprises at least one of a viewport size detector and an online connectivity detector.

26. A computer program product for adjusting a web application user interface (UI), the computer program product comprising a computer usable non-transitory storage medium having readable program code embodied in the storage medium, the computer program product includes at least one component operable to:
render the web application UI based on a document object model (DOM) and one or more cascading style sheet (CSS) rules;
detect at least one state change of the web application from a first state to a second state;
adjust one or more elements of the web application user interface (UI) in dependence upon the at least one state change, by changing a of class a UI element of the one or more elements in the DOM from a first class associated with the first state to a second class associated with a second state, wherein the one or more CSS rules include at least a first descendant selector that is associated with the second class and changing the class of the one or more elements applies one or more new properties to one or more sublevel elements of the UI element using the first descendant selector; and
render the web application UI with the adjusted one or more elements.
